(19) United States
(12) Patent Application Publication
(10) Pub. No.: US 2015/0262134 A1
(43) Pub. Date: Sep. 17, 2015

(54) Wireless Communications Methods and Systems for Juvenile Products

(71) Applicant: Thorley Industries LLC, Pittsburgh, PA (US)

(72) Inventors: Robert D. Daley, Pittsburgh, PA (US); Mary J. Koes, Pittsburgh, PA (US); Kevin Dowling, Westford, MA (US)

(21) Appl. No.: 14/660,503

(22) Filed: Mar. 17, 2015

Related U.S. Application Data
(60) Provisional application No. 61/954,332, filed on Mar. 17, 2014.
(60) Provisional application No. 62/045,859, filed on Sep. 4, 2014.

(51) Int. Cl. G06Q 10/00; G06Q 50/26

(52) U.S. Cl. CPC G06Q 10/20; G06Q 50/265

(57) ABSTRACT

Wireless communications methods and systems for juvenile products include a juvenile product and a mobile application for monitoring and/or controlling a juvenile product. The juvenile product includes at least one communication device and at least one sensor configured to sense at least one type of sensor data on at least one of the juvenile product, a juvenile using the juvenile product, and an environment of the juvenile product. A processor is configured to receive data from at least one user device; receive the at least one type of sensor data from the at least one sensor; and determine at least one state of at least one of the juvenile product, the juvenile using the juvenile product, and the environment of the juvenile product based on at least one of the data received from the at least one user device and the at least one type of sensor data.

### CROSS REFERENCE TO RELATED APPLICATIONS

This application claims the benefit of priority to U.S. Provisional Patent Application No. 61/954,332, filed on Mar. 17, 2014, and U.S. Provisional Patent Application No. 62/045,859, filed on Sep. 4, 2014, the entire contents of which are hereby incorporated by reference.

### BACKGROUND OF THE INVENTION

1. Field of the Invention

The present invention relates to juvenile products and, in some aspects, to wireless communications methods and systems for juvenile products.

2. Description of Related Art

Juvenile products, such as, strollers, car seats, boosters, playpens, and other home-based, portable, and travel products help keep infants and children safe, happy, or entertained. Many juvenile products have more than a single function, but are primarily directed to keeping the child safe or allowing the child to play safely. Some products involve set-up, takedown, installation, and operating processes that must be performed precisely so that the child remains safe.

Monitoring of children using juvenile products is desirable to insure their happiness and well-being. Recent generations of juvenile products offer increased capability to monitor children to further keep the children safe and make the use of juvenile products easier. Juvenile products providing increased capabilities can provide children, parents, and caregivers with a better experience, better use, and greater capabilities than products not enabled with such technology.

### SUMMARY OF THE INVENTION

Non-limiting examples of the present invention will now be described in the following numbered clauses:

Clause 1. A juvenile product comprising: (a) at least one communication device; (b) at least one sensor configured to sense at least one type of sensor data on at least one of the juvenile product, a juvenile using the juvenile product, and an environment of the juvenile product; (c) at least one processor in communication with the at least one communication device and the at least one sensor module, the at least one processor configured to: (i) receive data from at least one user device; (ii) receive the at least one type of sensor data from the at least one sensor; (iii) determine at least one state of at least one of the juvenile product, the juvenile using the juvenile product, and the environment of the juvenile product based on at least one of the data received from the at least one user device and the at least one type of sensor data; (iv) control the juvenile product based on at least one of the data received from the at least one user device, the at least one type of sensor data, and the at least one determined state; and (v) transmit status data to the at least one user device, wherein the status data is based on the at least one determined state, wherein the status data includes instructions to perform a maintenance operation or to upgrade or replace the juvenile product.

Clause 2. The juvenile product of clause 1, comprising at least one of the following: a car seat, a stroller, a booster, a playpen, a motion device, bouncer, high chair, or any combination thereof.

Clause 3. The juvenile product of any of clauses 1 and 2, wherein the at least one sensor comprises comprise at least one of the following: an accelerometer, a gyroscope, a pressure transducer, an audio transducer, an image capture device, a current sensor, a heat sensor, or any combination thereof.

Clause 4. The juvenile product of any of clauses 1-3, further comprising firmware embedded in the at least one processor or on a computer-readable medium, wherein the firmware is updated based on data received from the at least one user device.

Clause 5. The juvenile product of any of clauses 1-4, wherein the at least one processor is further configured to communicate the status data to a remote server computer, and wherein the remote server computer is configured to generate analytics data concerning use of the juvenile product over a period of time.

Clause 6. The juvenile product of any of clauses 1-5, wherein the at least one type of sensor data includes at least one of audio data and image data, and wherein the at least one processor is configured to process the at least one of the audio data and the image data to determine the at least one state of the juvenile using the product.

Clause 7. The juvenile product of any of clauses 1-6, wherein the at least one type of sensor data indicates a location of the juvenile product.

Clause 8. The juvenile product of any of clauses 1-7, wherein the at least one type of sensor data indicates a distance traveled by the juvenile product.

Clause 9. The juvenile product of any of clauses 1-8, wherein at least one type of sensor data includes physiological data of the juvenile using the juvenile product.

Clause 10. A mobile application for monitoring and/or controlling a juvenile product, the mobile application comprising at least one non-transitory computer-readable medium comprising program instructions that, when executed by at least one processor of a user device, causes a user device to: receive data from the juvenile product; generate at least one user interface comprising a plurality of selectable options for controlling the juvenile product; transmit data to the juvenile product, the transmitted data configured to control the juvenile product based on user input received through the at least one user interface; receive product registration input data from the juvenile product, the product registration input data including a serial number of the juvenile product; and transmit the product registration input data in association with user registration input data to at least one remote server.

Clause 11. The mobile application of clause 10, wherein the program instructions, when executed, further cause the user device to: retrieve instruction information from at least one server computer in response to data received from the juvenile product; and display the instruction information on the at least one user interface.

Clause 12. The mobile application of any of clause 10 and 11, wherein the program instructions, when executed, further cause the user device to: display an alert on the at least one user interface based on the status data received from the juvenile product.

Clause 13. The mobile application of any of clause 10-12, wherein the alert indicates at least one of the following: the juvenile product is improperly set-up, the juvenile product is improperly used, a battery level is low, the juvenile product has been used for longer than a predetermined period of time, the juvenile product is improperly configured, the juvenile product requires maintenance, the juvenile product requires an upgrade or replacement, or any combination thereof.

Clause 14. The mobile application of any of clauses 10-13, wherein the program instructions, when executed, further cause the user device to receive at least one of image data and audio data from at least one of a camera and a microphone integrated or on the juvenile product.

Clause 15. The mobile application of any of clauses 10-14, wherein the program instructions, when executed, further cause the user device to: determine a state of a juvenile based on the at least one of the image data and the audio data received from the at juvenile product

Clause 16. The mobile application any of clauses 10-15, wherein the program instructions, when executed, further cause the user device to: locate the juvenile product based on at least one of the following: GPS data associated with the juvenile product, signals received from the juvenile product, or any combination thereof.

Clause 17. The mobile application of any of clause 10-16, wherein the program instructions, when executed, further cause the user device to: transmit analytics data based on usage of the juvenile product to at least one remote server computer.

Clause 18. A wireless communication method for a juvenile product comprising: sensing, by at least one sensor, at least one type of sensor data on at least one of the juvenile product, a juvenile using the juvenile product, and an environment of the juvenile product; receiving, by at least one processor, data from at least one user device; receiving, by the at least one processor, the at least one type of sensor data from the at least one sensor; determining, by the at least one processor, at least one state of at least one of the juvenile product, the juvenile using the juvenile product, and the environment of the juvenile product based on at least one of the data received from the at least one user device and the at least one type of sensor data; controlling, by the at least one processor, the juvenile product based on at least one of the data received from the at least one user device, the at least one type of sensor data, and the at least one determined state; and transmitting, by the at least one processor, status data to the at least one user device, wherein the status data is based on the at least one determined state, wherein the status data includes instructions to perform a maintenance operation or to upgrade or replace the juvenile product.

Clause 19. The juvenile product of clause 18, wherein the at least one type of sensor data includes physiological data of the juvenile using the juvenile product.

Clause 20. The juvenile product of any of clauses 18 and 19, further comprising: transmitting, by the at least one processor, the status data to a remote server computer.

### BRIEF DESCRIPTION OF THE DRAWINGS

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limit of the invention.

Further features and other examples and advantages will become apparent from the following detailed description made with reference to the drawings in which:

FIG. 1 is a block diagram illustrating a manner in which functions or components for wireless communications methods and systems for juvenile products interact according to an example of the present invention; and

FIG. 2 is a block diagram of a juvenile product according to an example of the present invention.

### DESCRIPTION OF THE INVENTION

As used herein, the singular form of “a”, “an”, and “the” include plural referents unless the context clearly dictates otherwise.

As used herein, the terms “end”, “upper”, “lower”, “right”, “left”, “vertical”, “horizontal”, “top”, “bottom”, “lateral”, “longitudinal” and derivatives thereof shall relate to the invention as it is oriented in the drawing figures. However, it is to be understood that the invention can assume various alternative orientations and, accordingly, such terms are not to be considered as limiting. Also, it is to be understood that the invention can assume various alternative variations and stage sequences, except where expressly specified to the contrary. It is also to be understood that the specific devices and processes illustrated in the attached drawings, and described in the following specification, are simply examples of the invention. Hence, specific dimensions and other physical characteristics related to the examples disclosed herein are not to be considered as limiting.

For the purposes of this specification, unless otherwise indicated, all numbers expressing quantities of ingredients, reaction conditions, dimensions, physical characteristics, and so forth used in the specification and claims are to be understood as being modified in all instances by the term “about.” Accordingly, unless indicated to the contrary, the numerical parameters set forth in the following specification and attached claims are approximations that can vary depending upon the desired properties sought to be obtained by the present invention.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

Also, it should be understood that any numerical range recited herein is intended to include all sub-ranges subsumed therein. For example, a range of “1 to 10” is intended to include any and all sub-ranges between and including the recited minimum value of 1 and the recited maximum value of 10, that is, all subranges beginning with a minimum value equal to or greater than 1 and ending with a maximum value equal to or less than 10, and all subranges in between, e.g., 1 to 6.3, or 5.5 to 10, or 2.7 to 6.1.

As used herein, the terms “communication” and “communicate” refer to the receipt or transfer of one or more signals, messages, commands, or other type of data. For one unit or component to be in communication with another unit or component means that the one unit or component is able to directly or indirectly receive data from and/or transmit data to the other unit or component. This can refer to a direct or indirect connection that can be wired and/or wireless in nature. Additionally, two units or components can be in communication with each other even though the data transmitted can be modified, processed, routed, and the like, between the first and second unit or component. For example, a first unit can be in communication with a second unit even though the first unit passively receives data, and does not actively transmit data to the second unit. As another example, a first unit can be in communication with a second unit if an intermediary unit processes data from one unit and transmits processed data to the second unit. It will be appreciated that numerous other arrangements are possible.

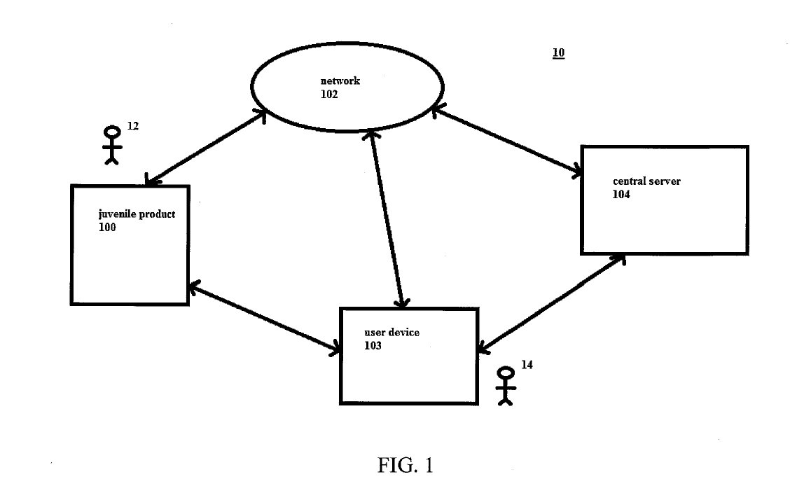

Referring to FIG. 1, a wireless communications system 10 for juvenile products includes a juvenile product or device 100, a network 102, a user device 103, and/or a central server 104. The system 10 provides reporting and monitoring of the status of the juvenile product 100 and its environment, as well as the status and safety of a child 12 using the device, and provides parents, caregivers, and manufacturers with status information, updates, and other capabilities.

The juvenile product 100 can be a stroller, a car seat, a booster, a playpen, infant seat, bouncer, high chair, or other home-based, portable, and/or travel product. The juvenile product 100 may be configured to sense, monitor, and act upon sensed or provided information to further keep the child 12 safe and make the use of such products easier. For example, in one implementation, the juvenile product 100 can be configured as a stroller, such as, the 4moms origami® stroller available from Thorley Industries, LLC. The stroller provides sensing and control of stroller configuration and state, including the presence of a child 12 in the stroller. Sensing, motion control, processing and other functions are integrated into the stroller to provide children, parents, and caregivers with a better experience, better use, and greater capabilities. In other implementations, the juvenile product 100 can be configured as a playpen, such as, the 4moms breeze® playpen, or as an infant seat or a rocker, such as, the 4moms mamaRoo® infant seat or the 4moms rockaRoo® rocker, each of which is available from Thorley Industries, LLC.

The network 102 may include an intranet, the Internet, a local area network (LAN), and/or any other wired or wireless networks, such as, the public switched telephone network (PSTN), a cellular data network, etc. The juvenile product 100, the user device 103, and/or the central server 104 may be connected to the network 102 via direct or indirect connections that can be wired and/or wireless in nature.

The user device 103 may be a smartphone, such as a smartphone executing a version of Google Android® OS or Apple iOS®, a tablet computer, such as, the Apple iPad®, a desktop computer, or any other computing device capable of executing functions of the user device 103 described herein. The user device 103 is configured to execute an application to interact and communicate with the juvenile product 100 and the central server 104, provide a graphical user interface (GUI) to a user 14, and receive input from the user 14 for controlling the juvenile product 100 or transmission to the central server 104.

Upon initial power-up of the juvenile product 100 for the first time, the user may be requested to download the application to their user device 103 and provide user information, such as, a date of birth, a weight, an age, a height, and/or a gender of the child 12 using the product and/or information associated with the user such as, a mailing address, an email address, a telephone number, and/or other contact or descriptive information of the user. The user information can be used to assess any required changes in the configuration, initial setup, or operation of the juvenile product 100. For example, applicable laws, regulations and guidelines may determine a required configuration or adjustment based on the user information. In another example, sensed means that the product must accommodate many particular configurations to be safe and useful and can be used to adapt or adjust the juvenile product 100 automatically or by the customer to insure a safely installed juvenile product 100. The application can also be used to select and choose from a variety of language choices for use of the application itself and the juvenile product 100. If the various languages cannot be all stored locally on the juvenile product 100 or with the downloaded application, the application can download a different operating language and/or a localization instruction manual set.

When the user 14 connects the user device 103 to a new juvenile product 100, e.g., by establishing a wired or wireless connection to the juvenile product 100, the application determines the serial number of the product and prompts the user 14 to register the product with the central server 104. The application submits a registration to the central server 104 that associates the juvenile product 100 and a serial number of the juvenile product 100 with the user and the user information, e.g., a unique user identification number, in a registration database. The registered information and product information collected by the juvenile product 100 during its setup and operation can also be provided in real-time to or accessed in real-time by a manufacturer to determine a state of the juvenile product 100. Such information can be used to diagnose any issues with the product and to assist the user 14 with any issues or situations. In one implementation, the central server 104 or other computing device operated by the manufacture or technical support may establish a direct connection to product to access the registered information and information collected by the juvenile product 100 to diagnose errors and issues.

The central server 104 receives the user information from the user 14 and the product information from the product through the user device 103 and/or directly from the juvenile product 100, as shown in FIG. 1. The central server 104 can use the stored data to profile products, run regressions and statistical analyses on product performance to provide quality assurance (QA) data, and collect information to detail the environmental conditions in which the product has operated. As one example, the central server 104 may determine based on the stored information including the product serial numbers that a certain manufacturing run associated with a particular batch of serial numbers are operating or exhibiting certain characteristics, e.g., not operating as expected or within normal operating parameters.

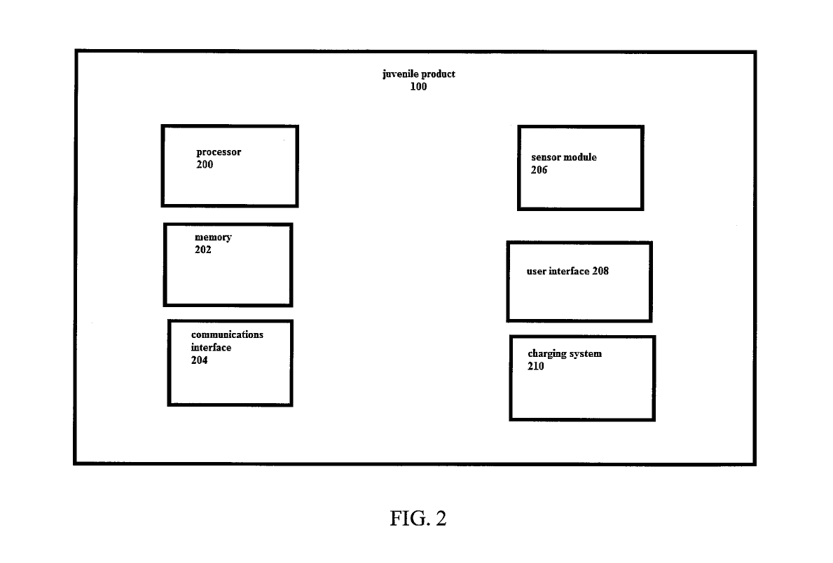

Referring to FIG. 2, the juvenile product 100 may include a processor 200, a memory 202, a communication module 204, a sensor module 206, a user interface 208, and/or a charging system 210. The user interface 208 may include a touch screen display providing the GUI or another interface configured to output information to the user 14 and receive input from the user via the application executing on the user device 103. The communication module 204 can be controlled by the at least one processor 200 to provide various devices for communicating information to and from the user device 103, the central server 104, and/or other external devices. For instance, the communication module 204 can include a GPS transceiver, a Bluetooth transceiver, a ZigBee or other home automation based protocol transceiver, a near field communications (NFC) transceiver, a Wi-Fi modem, and/or a cellular modem. The communication module 204 is configured to communicate with the user device 103 either directly via device-to-device communications, e.g., via a paired Bluetooth connection, NFC, or 6LoWPAN (the Internet of Things), or indirectly via the network 102, e.g., using cellular data network capability of the cellular modem. The cellular data network capability may use a machine-to-machine (M2M) communication scheme through a service that connects the product to network or cloud-based servers, which can be accessed by the user device 103 for a variety of purposes discussed herein. The communication module 204 is configured to communicate with the central server 104 via the application executing on the user device 103 and/or via the network 102, e.g., using the cellular data network capability of the cellular modem.

The GPS transceiver in the communications module 204 may determine and record a location of the juvenile product 100. The juvenile product 100 may regularly transmit its location to the user device 103 or the central server 104 or transmit its location in response to a request from the user device 103 or the central server 104. When the user 14 initiates a location feature on the application, the application requests the location from the juvenile product 100 or pulls the last received location of the juvenile product 100 from the memory of the user device 103 or the central server 104. The location may be provided or displayed to the user 14 as an address and/or a map with a marker for the location of the product, e.g., as a pin in Google Maps®. For example, a locate command in the application, which is similar to applications for finding automobiles, e.g., the LoJack® system, may provide the location of the juvenile product 100, e.g., a location of a lost stroller. In one example, a lock command may be sent to the juvenile product 100 to remotely lock or disable the product from the user device 103, e.g., to lock the wheels of a stroller to remotely prevent someone from taking and using the stroller. For example, such a communication may be sent from the user device 103 to the juvenile product 100 through Bluetooth®, if the devices are in close enough proximity, or use another communication means, such as, Wi-Fi to communicate the command to the juvenile product 100. In one example, upon notification from the user device 103, the central server 104 may register a particular juvenile product for a searching or tracking program such that if the product is activated, a notification is automatically sent from the juvenile product 100 to the central server 104, which can notify the user device 103 of the activation and location of the juvenile product 100.

The processor 200 may control the communication module 204 to communicate instructions and installation videos to the user device 103 for setting up and operating the juvenile product 100. The instructions and installation videos may be stored in the memory 202. The memory may be an onboard Flash memory, a ROM, rotating media, a solid-state memory, or other system or computer readable medium having storage capability. In some examples, the juvenile product 100 may provide a location, such as, a website or URL, to provide a link to the user device 103 to download the instructions or installation videos. The instructions or installation videos may be updated, for example, by the central server 104, on the juvenile product 100 or at the web accessible location to provide updated or more recent information about the use and care of the juvenile product 100.

The sensor module 206 can be controlled by the at least one processor 200 to sense various parameters or states of the juvenile product 100, a child 12 using the product, or an environment in which the product is being used. The sensor module 206 may include various sensors and sensor-based output, examples of which are listed below in Table 1 and described herein in more detail with respect to various examples.

TABLE 1

| Sensor/Output Type | Sensed/Output parameter/state |
|---|---|
| Distance | Distance traveled |
| Time | Time, e.g., for splits, travel time, feeding time, |
| | movement time, etc. |
| Temperature/ | Local temperature, pressure, moisture, wind, |
| Environment | forecast |
| Communication | Amount of data sent/received; texts, calls, emails |
| Alert | Display texts, calls, emails on juvenile |
| | product interface |
| Expanded Stroller UI | Access to stroller controls data with more real |
| | estate |
| Image/Video Capture | Peekaboo cam, baby go-pro, video chat, collage |
| | of baby's first sights and reactions |
| Detailed Charging Info | Rate of charging, power allocation, |
| Lighting | Mood lighting, preset or customizable lighting |
| | scheme |
| Terrain Monitoring | Avoiding rough rides |
| Location | Security system, who has stroller, where is |
| | stroller, where is nanny |
| Fitness | Control generator resistance, monitor heart |
| | rate/calories burned, speed, distance goal |
| Social | A user club, social challenges i.e., store |
| | visits, distance traveled, check-in |
| Child Presence | Notification of unexpected sensor deactivation |
| Stroller Status | Open, closed, in between, battery level |
| Brake Activation | Stroller lock, runaway prevention |
| Anti Fold/Open | Lock stroller in current state |
| Radio Communication | Real time stroller location |
| Travel System | Infant odometer coupled with infant seat, latch |
| | status, lock status |
| Child Health Monitor | Physiological parameters, e.g., temperature, |
| | breathing, sleep sensing, pulse |
| Geo - Tagging | Geographical identification of current location |
| | for social interaction |
| Weather Notifications | Display weather reports, e.g., severe weather |
| | notifications on stroller UI |
| Time of Day | Acquire current time of day from user device |
| | and display on stroller UI |
| Automated Product | Automate product registration process by |
| Registration | automatically obtaining product serial number |
| | over wireless communication technology |
| Power Control | Remote control power state of an infant seat |
| Control Motion | Control the motion of infant seat |
| Control Speed | Control speed of motion for infant seat |
| Control Sound | Control audible sound of an infant seat |
| Control Volume | Control volume of sound for an infant seat |
| Installation Status | Display car seat installation status on |
| | automobile infotainment system |
| Error Codes | Store, push to 4moms, pop-up description, quick |
| | troubleshoot guide |
| Diagnostics | Compare motor draw, battery −> prompt charge/ |
| | replace, failed fold open |
| Data Collection | Usage details, durability, location and scenario |
| | utilization |
| Firmware Updates | Notify and push firmware update |

In one implementation, the sensor module 206 includes one or more sensors configured to determine whether the juvenile product 100 has been properly setup or is being operated properly, and the processor 200 may control the communication module 204 to communicate instructions or warnings to the user device 103 if the juvenile product 100 is improperly setup or operated. For example, sensors may determine if different elements of the juvenile product 100 have been connected and connected in the correct configuration and motion and angle sensors may determine if the product is being operated in a dangerous manner, e.g., at too high a speed, at too severe of an angle, etc. The juvenile product 100 can thus inform the user 14 that a situation requires examination of information to correctly operate or setup the product. A user manual for the juvenile product 100 may be stored in the memory 202 and accessed by the user device 103 or communicated to the user device 103 by the communication module 204 in response to a request from the user device 103. In another example, the user manual may be stored for the juvenile product 100 may be stored in the central server 204 and accessed by the user device 103.

The sensor module 206 may comprise a battery sensor configured to sense a stored energy level of a battery of the charging system 210 of the juvenile product 100. The processor 200 may control the communication module 204 to communicate updates on the energy level in the battery or provide a notification when the energy level is below a threshold level to the user device 103. For example, the updates or notifications may be sent via text message, email, or a direct communication with the application on the user device 103. The sensor module 206 may include a sensor configured to monitor a state of rechargeable batteries of the charging system 210 of the juvenile product 100, and the processor 200 may control the communication module 204 to communicate indications and warnings with respect to an estimated life of the batteries and an estimated time for replacement of the batteries to the user device 103. For example, the sensor may monitor the energy storage efficiency and/or the charging efficiency of the batteries.

The sensor monitor 206 may comprise one or more sensors configured to determine various states of components the juvenile product 100, such as, a belt tension for a restraining belt, incorrect belt installation, incorrect belt angle, a status of whether the belt is buckled, and/or a lap or latch status, and the processor 200 may control the communication module 204 to communicate notifications to the user device 103 and/or provide notifications from the juvenile product 100 in response to the detected states. In one implementation, for a juvenile product 100, such as, a play yard (play pen), the notification can include an indication of proper set-up and assembly. The juvenile product 100 or the application on the user device 103 may provide general safety notes and instructions on when to change the product's orientation, lap, or latch configuration based on the sensed data.

In another implementation, the juvenile product 100 is a high chair, and the sensor module 206 comprises a sensor configured to measure a motion or tipping of the chair and/or a tray attached to the chair, and the processor 200 may control the communication module 204 to communicate an alert if the motion or tipping exceeds a threshold level. The sensor module 106 may comprise a sensor configured to determine if the tray is connected to the chair, and can trigger an alert if the tray is determined to be disconnected.

The processor 200 may control the communication module 204 to provide general safety notes stored in the memory 202 to the user device 103. The safety notes may be updated when a connection is established between the user device 103 and the central server 104. Manuals and use updates, indications of recalls, expiration dates, and changes in law or regulations surrounding the juvenile product 100 may be provided to the user device 103 and/or the juvenile product 100 from the central server 104. Additionally, such changes or advertising of new products that may be useful to the user 14 may be provided to the user device 103 and/or the juvenile product 100 from the central server 104. The application on the user device 103 may be configured to interface with social media such that the user 14 may interact with other parents and caregivers so that users on Facebook, Twitter, Pinterest, Foursquare, Google+ and any other social media sites can be connected to share experiences, meet, or simply provide communication and updates to other users.

In another example, the sensor module 206 may comprise a sensor configured to measure a motor current, a sensor configured to measure wheel vibrations, and/or a sensor configured to measure a force or stress exerted on an element of the juvenile product 100. The processor 200 may control the communication module 204 to communicate warnings or statistics that can be used for preventive maintenance, for example, when motor currents, wheel vibrations, and/or frame parts violate one or more thresholds. These measurements may correspond to dimensional wear, changes or alterations in the movement and control of the juvenile product 100.

In one implementation, the juvenile product 100 may include heating and cooling elements integrated into the product that can be used to warm or cool the child 12. Heating elements, such as, resistances or thermo-electric coolers (TEC) that use the Seebeck or Peltier effect (one is the inverse of the other) can be used for such heating or cooling capabilities. The heating and cooling elements may be remotely controlled or selected by the application on the user device 103 and/or in response to sensor output from temperature sensors in the sensor module 206 detecting one or more conditions associated with the juvenile product 100. For example, the cooling element may be activated if the temperature of the environment surrounding the juvenile product 100 or the child 12 is above a threshold level.

The sensor module 206 may comprise pressure sensors or strain sensors configured to provide weight sensing and ongoing information that tracks baby weight progress. This data can be used to chart weight and growth over time and certain milestones in the product configuration can be realized from this information. Excess weight for a particular product can also be used to determine and inform the parent if a new product or adjustments should be made to the current product. For example, in response to a weight and/or height of the child 12 satisfying one or more threshold application may recommend or require that a configuration of the juvenile product 100 be changed to account for growth of the child 12. This includes, but is not limited to the direction of a car seat. Collected data can be used for a variety of purposes as discussed hereinafter.

In another implementation, the sensor module 206 may comprise one or more weather sensors and/or receive information via the communications module 204 from a weather service. The processor 200 may process the weather related data and/or information to determine weather or local conditions. For example, weather conditions received via the network 102, e.g., via WiFi or cell networks, may be displayed on the juvenile product 100 or on the user device 103.

The sensors in the sensor module 206 themselves may be sensed and monitored. Many sensors in the product can be checked and monitored including, but not limited to current sensors in motors, states of open and closed switches used for travel, presence, temperature, pressure, force and more. Sensing of the child 12, the state of the product, and the environment can be used to sense, control, and act upon the product.

The product can provide the capability to measure physiological parameters or other states of the child 12 through heart rate, respiration, temperature and other physiological measures. Sensors integrated directly into the product, such as, pressure, temperature, ECG, and EMG sensors, may be used to measure the physiological parameters of the child 12. The communications module 204 of juvenile product 100 may communicate with clothing and apparel that has built-in sensing and communication functions through a wireless or wired means such that lower-power on-body or in-apparel devices can be provided to enable reliable communication to monitor healthy, sick, or disabled children during transport, sleep, or awake states.

The sensor module 206 may include environmental measures to monitor environmental parameters, such as, the temperature of a car on hot days. Single sensing modalities, such as, temperature, provide a useful indication of a particular measure; however, additional functionality can be realized though the combination of sensed information. The term ‘sensor fusion’ describes powerful combinations of sensed measurements used to provide status and state information that is indirectly measured through such combinations. Estimation of product state can provide, in one non-limiting example, estimations of location or stability of the product. For example, motion sensing using accelerometers and gyroscopes combined with inclination can provide information that a device is about to tip over. The combinations of sensed information can be used to create better data representation and new forms of information. In another non-limiting example, a combination of elevated stress of a child 12 through motions sensed by force sensors and temperature can be used to determine if a child 12 is agitated and at risk. Conversely, a lack of motion and reduction in physiological data, as well as elevated temperature, may indicate issues not directly reflected by any single measurement.

The sensor module 206 includes sensors that can track a distance travelled by the juvenile product 100, e.g., the GPS. Odometry, the measurement of distance traveled, can be determined through the use of encoders on the juvenile product 100, or GPS and IMU (inertial measurement unit) devices to provide a capability similar to that of pedometers that measure distances walked. A “Map my walk” feature on the application may enables distance and travel information to be transferred from the juvenile product 100 to the user device 103 and/or to the central server 104 where the data can be accessed, plotted, visualized and/or compared to data of other users. For example, the juvenile product 100 may provide tracking features similar to This to features provided by wearable health devices, such as, Fitbit®, Jawbone®, or Bodymedia® devices, which have systems used to track healthy lifestyles and are used for fitness tracking or weight management. A juvenile product 100, such as, a stroller, can also be used for these health tracking purposes and give a direct measure of how far a child 12 has been pushed, walked, etc., as described in more detail below. Similarly, in real-time, such systems can be used to track rates of speed, minutes per mile, calories burned by the user 14, etc. Odometry, in conjunction with inclination, can be used to measure terrain and give an elevation map of a trip. This can be used to determine total elevation climbed over the course of a journey. This terrain monitoring can be used to gather data about a walk or combined with other stroller information by other users to capture detailed terrains in many areas, such as, sidewalks, curbs and even provide details of area that are avoided by parents. Millions of stroller miles can be combined at the central server 104 to give very accurate terrain maps and/or provide mapping by strolling for detailed ‘street view’ information for Google® and others.

In one implementation, the juvenile product 100 is a stroller, and wheels of the stroller may be coupled to generators for the purpose of powering or charging the energy storage device of the charging system 210 of the juvenile product 100 to power or charge mobile phones and other electronic devices that may be connected to the charging system 210. The sensor module 206 may include sensors configured to monitor a status of the energy storage device, an amount of energy generated by the charging system 210, an amount of energy dissipated from the energy storage device, and a discharge rate of the energy storage device. This data can be used by a customer for information purposes, or by the manufacturer to assess performance of such subsystems. The processor 200 may determine a rate of charge and an effectiveness of the charge rate based on the sensed data, and this charging information can be combined with a speed sensed by a movement sensor configured to sense a speed of the stroller to determine if the charging system 210 is operating in a normal manner, e.g., efficiently charging the energy storage subsystem based on the speed of the stroller. The processor 200 may control the charging system 210 to operate in an efficiency mode that can be targeted for walking at a certain speed based on the data from the movement sensor, wherein the stroller or mobile product provides the current rate and transmission to a mobile phone for charging, and wherein the information is displayed in real-time on the juvenile product 100 or the user device 103 with an indication of whether to speed-up or slow-down to maintain a desired charging efficiency.

In one implementation, the juvenile product 100 is an infant seat, such as, the 4moms mamaRoo® infant seat, that can be controlled remotely by the user device 103. The user device 103 may command the juvenile product 100 to perform preset motions that have been designed by the manufacturer and stored in the juvenile product 100, for example, the user 14 may select between multiple preset motions that have been preprogrammed in the juvenile product 100, e.g., a rocking motion, a rolling motion, and a swaying motions, each with different motion paths.

In one example, the user device 103 and the juvenile product 100 are connected to a the network 102, which may include a cloud network, and local networking is used to enable long-distance communication with the infant seat. For example, if the user 14 is at work and wants to soothe the child 12 remotely, the user 14 can use the user device 103 to send a command to the juvenile product 100 to control the motion or vibration of the seat. The juvenile product 100 may provide an infant monitoring system including an audio and/or video feed to the user device 103 to enable the user 14 to view the child 12 receiving the commanded motion so that the user 14 may enjoy the vicarious experience of soothing the child 12, leading to a greater feeling of closeness with the child 12.

In addition to sending custom motion patterns to the juvenile product 100, the user 14 may send recorded audio and/or video to the juvenile product 100 for playback on a display and/or speakers of the juvenile product 100. For example, the user 14 may record himself singing a lullaby, or making a special noise that makes the child 12 happy, and send the recorded media to the juvenile product 100 for playback. A pre-recorded message ready to play on the juvenile product 100, e.g., stored in the memory 202 of the juvenile product 100, may help secondary caregivers, such as, nannies, daycare attendants, and/or grandparents to provide familiar soothing to the child 12 in the event that they become distraught. For example, audio and/or video may be recorded on the user device 103 and saved as an .mp3, .mp4, or other file format. The recorded media is transmitted to the juvenile product 100 and stored in the memory 202, and may be recalled via the user interface 208 of the juvenile product 100 or the user device 103.

For some juvenile products, such as, car seats, the user 14 may desire to set up a regular or periodic diagnostic check of the juvenile product 100. The application may provide a scheduling function that enables the user 14 to select a recurring time at which the juvenile product 100 runs a full diagnostic test on itself. The application synchronizes with an on-board clock in the juvenile product 100 to create a scheduled event, and the next time that the user 14 connects the user device 103 to the juvenile product 100, the user device 103 receives a full diagnostic report of the last diagnostic check run on the juvenile product 100. The diagnostic data may be transferred to the central server 104, e.g., directly from the juvenile product 100 or from the user device 103, to be available to all operators of the juvenile product 100 who are not physically present to review the diagnostic, e.g., other users with applications registered with the juvenile product 100.

The information collected by the sensors of the sensor module 206 and/or processed by the processor 200 may be stored and/or aggregated to provide users and manufacturers with useful data that can be used to determine where, when, and how the products are being used, and to further improve the product. For example, the collected and processed information may include a number of car seat installations or performance data on the use of strollers. This meta-data can be used to reveal trends in the use, location, or status of products in the marketplace. Data collected in this way is very useful for targeted advertising and updating product information. Tying in GPS information from a smart phone can provide location-based information on the types of climates and terrains in which the products are being used. Privacy restrictions and the use of encryption may be placed on the information to avoid direct identification of and access to users.

The user device 103 and the juvenile product 100 may be connected to the central server 104, for example, by the network 102, e.g., a cloud network, to provide data aggregation and data mining functions. By attaching video and sound monitors to the juvenile product 100, the child 12 can be observed and recorded interacting with the juvenile product 100 so that the central server 104 can process the data to learn what settings on the product are associated with which moods of the child 12.

For example, settings may be customized to a specific child and/or generalized for all children by taking images and recording audio of the child 12, and comparing the data to data of children in different states, such as, “happy”, “upset”, “crying”, “sleeping”, “alert”, “peaceful”, etc. The system 10 may use the received data and determine which category the data for a specific child falls into to label the mood of the child 12.

The juvenile product 100 may collect data on state changes of the juvenile product 100, such as, a changed motion for an infant seat, a car seat installation state, or a stroller folding state; error codes, such as, an obstruction error on an infant seat or the belt being in an incorrectly latched state for a car seat; duration data, such as, the juvenile product 100 being in a particular state, e.g., an infant in a wave motion or a stroller in movement on a walk, for a particular period of time; a number of cycles, e.g., a number of swing cycles for an infant seat, etc.

The collected data may be correlated to settings of the juvenile product 100 to create specialized settings particular for the child 12. For example, the system 10 may determine that a slow kangaroo motion with soft audio of the ocean is a quickest or best combination of settings to stop a particular child from crying. In another example, a wave motion with loud fan audio may be determined to help the child 12 to sleep. A profile for each child may be created in the system 10, and the settings for the child may be based on time of day, the child's patterns, age, weight, and/or other characteristics.

The central server 104 may receive the collected data and calculate a setting that performs a specific function for the most children. For example, the setting may be determined based on the child's age, to create data that has determined that, on average, a 3-week old infant prefers a wave motion to stop crying, or that a 4-month old infant prefers rain audio to stop crying. These statistical averages may be used as defaults for a child just getting the infant seat who does not have custom presets yet defined for them.

The user device 103 or the juvenile product 100 may determine more frequently selected motions and speeds to identify a particular mode of the user 14, for example, “I am a kangaroo 3 mom.” or “I am a wave 5 dad.”

The system 10 may evaluate over time a duration that the child 12 has been in the car seat to estimate when the child 12 should be moved to the next size increase of a car seat.

In another example, if a battery failure is determined to be occurring in a given product, a previous month's data can be used to build a heuristic or analytical model of the behavior of the juvenile product 100 prior to the failure. This heuristic is matched to other products in the field to anticipate the battery failure and perform predictive support for the user 14, e.g., sending the user 14 a new battery before the current battery fails.

Data aggregation and mining may be used for custom preventative maintenance. For example, data collected on a juvenile product 100, e.g., an infant car seat, about battery usage, stress points, sensor information, or operating habits can be sent via the user device 103 to the central server 104 at which the performance of the juvenile product 100 can be tracked and qualified to ensure peak performance through the product's lifecycle.

If a situation arises where the data indicates to the central server 104 that the product is not performing as it should, a notification can be sent to the user device 103 with instructions to either perform a maintenance operation on the product or to have the product replaced by the company. Similarly, the central server 104 may track of any failures which occur for particular products and/or batches of products and correlate the failures to either a time point in the product lifecycle or the production batch that the product came from, e.g., using serial numbers and date codes recorded as a signifier of manufacturer batch). Other users who have that same serial number may be alerted about the potential for a particular issue based on the tracked data in a way that ensures that any poor performance is anticipated and diverted so as not to cause difficulty for the user 14.

In some implementations, the juvenile product 100 has specific functions which lend themselves to logging performance data; however, if a particular product does not have a networked connection, it becomes difficult for the product to report that data without going through a networked hub, such as, the user device 103. Accordingly, the juvenile product 100 may urge the user 14 to connect with the product on a regular basis for the retrieval and transmission of logs. Blatantly asking a user to connect to the product provides a poor user experience and could lead to doubts about the reliability of the product. The juvenile product 100 may instead provide the user 14 with a reason to connect to the product regularly to facilitate these log retrievals. Such reasons may come in the form of social interactions with either their own personal network or the network of product users curated by the company.

For example, meaningful content additions may be presented to the user 14 via the application on the user device 103 to encourage frequent use of the application and use with and around the juvenile product 100 to ensure regular delivery of device-collected data. Push notifications from the central server 104 or the juvenile product 100 to the user device 103 may encourage the user 14 to take picture of the child 12 while in their car seat to create a virtual scrapbook of baby's growth and progress. The scrap book may be uploaded and shared via social media and/or a manufacturer's website. While the user 14 is taking a picture of the child 12 in car seat for upload via the application, the application may be synchronized with the juvenile product 100 to gather data from the product. For example, the user 14 may be encouraged to document travels with pictures or anecdotes, and when the application is running and near stroller, the data that the stroller has gathered is collected by the application and/or uploaded to the central server 104. For example, to facilitate the retrieval of car seat logs, the application may prompt users to take pictures of the child 12 going for a ride every week to create a scrapbook of the baby's rides. While this is happening, log loading may occur in the background. Additionally, these pictures may be used to determine if the child 12 is outgrowing the car seat and needs to upgrade to a larger model.

To facilitate the retrieval of stroller logs, the application may provide features to track a distance traveled by the juvenile product 100 or the user 14, and compare the distance with a group of other stroller-users in the area, to show how many miles the user 14 has gone relative to the group. The user 14 may be prompted to take pictures of their child 12 to document the trips the child 12 is going on so that the user 14 can have a scrapbook of all of the child's trips.

The central server 104 may provide software updates to the juvenile product 100 and/or the application executing on the user device 103. The software updates may be hosted on the server 104 and may be generally available to the public. New functions and capability through such updates can provide bug fixes or new features. Updates may designate a new product or feature from the manufacturer that addresses a next stage in the life and growth of the child 12.

When the user 14 opens the application on the user device 103, the application connects the user device 103 to the juvenile product 100 and requests a current firmware version of the juvenile product 100. If the firmware version of the juvenile product 100 is less than the most current firmware image, the application prompts the user 14 to confirm the update, and if confirmed, sends a request to the server 104 for the new firmware. In one implementation, the customer is prompted by an alert on the application or through email, a pushed notification, or via text message. A link can be provided that establishes the connection and begins to download the firmware to the juvenile product 100. Known means of updating the firmware without risk to the operation of the device can be employed to preserve functionality in the event of a disruption during the downloading process. In another example, implementation of new firmware can be initiated by a special sequence of button presses or sensor actuation on the juvenile product 100 or in the application on the user device 103. Resetting and updating the firmware can be initiated once the sequence is complete.

The server 104 authenticates the request and sends the firmware image to the user device 103. When the application receives the firmware image, the application informs the juvenile product 100 of the firmware update. The product 100 enters a firmware update mode, and requests the new firmware from the application on the user device 103. As the juvenile product 100 downloads the new firmware, from the user device 103, the juvenile product 100 writes the new firmware to a reserved section of memory. This allows the current functioning firmware and the new firmware to live side by side on the product. If the update process fails, the juvenile product 100 reverts to using the old firmware instead of the new firmware. For example, to avoid ‘bricking’ the product, and to make the process fault tolerant, a special area of memory can be used to store the new update, and CRC, parity, or checksums can be used to insure complete transmission of the new update. If interrupted, these checks on transmission reliability will not be correct and the update is not completed.

Once the update has been downloaded to the product, the juvenile product 100 informs the application of either success or failure for the installation, and executes the appropriate firmware. The application updates and registers information associated with the update in a customer database. The server 104 stores a database of the available firmware versions for different revisions of a product. In this way, changes that only affect a particular batch of products may be available only to those affected units.

The application can provide an uninstall function to revert the juvenile product 100 to an earlier configuration or software version, to enable the juvenile product 100 to be configured or used for another child, and/or to reset the juvenile product 100. The juvenile product 100 or the application can also provide a “check engine light” notification that something needs to be assessed and checked on the product. The software and hardware may indicate that, due to a particular state of the product, “Do not use. Call customer service.” This message can be displayed on the product 100 itself or sent via wireless communications to the user device 103.

Some juvenile products 100, such as, the 4moms origami® stroller, provide lighting capabilities so others can see the stroller under dark conditions and/or illumination ahead of the stroller when walking in darkness or low-light conditions. Such lighting can use OLEDs or LEDs to provide light. Combinations of colors of light can be used to mix and provide decorative effects, and the lighting can be addressed and networked on the product to provide useful or decorative lighting effects such as strobes, steady illumination, pulsing, color change, etc. Lighting effects, such as ‘hover lights’, can be used to illuminate the ground beneath the stroller using LED lighting that is pointing downwards. The lighting effects can be coordinated and provide fun decorative lighting or even be used as warning or emergency lighting. The lighting effects can be remotely controlled or selected by the application on the user device 103 and/or in response to sensor output from the sensor module 206 detecting one or more conditions associated with the juvenile product 100, e.g., automatic lighting in dark or low light conditions.

The application on the user device 103 can be used to remotely control aspects of the juvenile product 100, such as, the geometry of reclining, inclination, level, and other adjustments to the product. A motor control on the juvenile product controlled by the processor 200 may control these functions in response to commands sent from the user device 103.

The system 10 can use knowledge of the birthdate of the child 12 to trigger a ‘Happy Birthday’ song or other song on the juvenile product 100 or the application to mark the occasion. The juvenile product 100 can mark the occasion and provide celebration using music or other stimulus for the child 12 on their special day. Other holidays and events can be similarly managed through words, music and song using an internal sound system of the juvenile product 100, or by the juvenile product 100 or the user device 103 communicating with an external audio/video system, e.g., an automotive audio system for those product installed in automobiles.

The juvenile product 100 may include imaging devices, such as, cameras, or other light and electro-magnetic radiation detectors of varying resolution. The imaging devices can be used to transmit imagery of the child 12 or environment to the user device 103 to monitor the state of the child 12. In one example, the camera may be mounted into the carrying handle, side bolsters, or attachment to the car seat or car, or to a rocker or seat of a high chair, and transmitted to a display elsewhere in the car on the user device 103 so that the child 12 can be safely monitored without impairing the driver or another passenger. The imaging device, such as a digital camera, can also be integrated into the sunshade of a stroller.

Multiple cameras may offer the capability of observing a face of the child 12 and what the child 12 is viewing. For example, on a trip to the zoo, the reaction of the child 12 to an animal and the animal itself can be recorded simultaneously, and the recorded video can be split-screened automatically in a two-camera record mode, and stored locally and sent individually later to the user device 103. A ‘baby's eye view’ can be used to record and display what the child 12 is seeing and sent via the user device 103 to a relative or other person.

Such a system could transmit images for processing by the user device 103 or the central server 104 to recognize faces or be processed to provide heart rate information, such as, described in research done by William Freeman and his research group at MIT published as Frédo Durand, et al., A World of Movement Scientific American, Volume 312, Number 1, January 2015; Michael Rubinstein, et al., Revealing Invisible Changes In The World, Science Vol. 339 No. 6119, Feb. 1, 2013; and Hao-Yu Wu, et al., Eulerian Video Magnification for Revealing Subtle Changes in the World, ACM Transactions on Graphics, Volume 31, Number 4 (Proc. SIGGRAPH), 2012, the contents of each of which is hereby incorporated by reference in their entirety.

Additional recognition capability may include emotional state recognition, e.g., (happy, sad, crying, smiling, or asleep or awake states of the child 12.). State recognition capability can be tied into a display on the juvenile product 100 to make an active and responsive system that reacts to the child 12 to cheer them up or quiet them down. Animated figures may be used to respond to the emotional state of the child 12 or even a virtual avatar of a parent or friend or animal can be used to connect to the child 12 and facilitate change in their emotional state. Verbal responses could be used as well to soothe the 12 child with pre-recorded messages or songs created by loved ones.

Information on a state of the child 12 can be used to activate an inclination of a car seat or change the motion or responsiveness of a product, such as, a car seat, bouncer, etc. These actions in response to state information can soothe the child 12 while driving or even be controlled remotely from the user device 103. The imaging system can also be used to monitor correct harness placement through processing of the image to delineate seat devices from the child 12. The extraction of such features in a known context can be accomplished through machine vision techniques, such as, filtering and convolution.

A display integrated to or attached to the product can be used to display the face of a parent or caregiver in the car or even in communications with a relative or friend or display a video. Such a display is useful in that the configuration of the car seat may not allow face-to-face contact in a car or elsewhere. The display can be used to comfort, educate or entertain the child 12 including interactive systems that utilize video and audio feedback.

A sound system integrated into the juvenile product 100 can be controlled remotely by the user device 103, and the user device 103 may and transmit or stream audio of an appropriate nature to soothe, excite, or grab the attention of the child 12. Programs and podcasts of particular interest to the child 12 can be remotely sent to the child's play device, such as, a stroller, car seat, playpen, swing, bouncer or other device supporting and holding a child 12. The sound system may have an integrated noise cancellation system to reduce the sound and the effect of ambient noise. The sound system be used to tell a story and provide a visual narrative through the use of an integrated or attached display to keep the child 12 calm and occupied at desired times. The juvenile product 100 may include a microphone that can be used in conjunction with video to record audio of the child 12 in the product. Analysis of audio signals could be used to judge emotional state (happy or sad) and take action depending on the desired state. If a remedy does not work (for example, music, or a spoken synthetically generated or recorded voice) another remedy can be tried, such as, soothing recordings, e.g., crickets, or waves on the shore, or rain.

Although the invention has been described in detail for the purpose of illustration, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment may be combined with one or more features of any other embodiment.

Other examples are within the scope and spirit of the description and claims. Additionally, certain functions described above can be implemented using software, hardware, firmware, hardwiring, or combinations of any of these. Features implementing functions may also be physically located at various positions, including being distributed such that portions of functions are implemented at different physical locations.

The invention claimed is:

1. A juvenile product comprising:
(a) at least one communication device;
(b) at least one sensor configured to sense at least one type of sensor data on at least one of the juvenile product, a juvenile using the juvenile product, and an environment of the juvenile product;
(c) at least one processor in communication with the at least one communication device and the at least one sensor, the at least one processor configured to:
(i) receive data from at least one user device;
(ii) receive the at least one type of sensor data from the at least one sensor;
(iii) determine at least one state of at least one of the juvenile product, the juvenile using the juvenile product, and the environment of the juvenile product based on at least one of the data received from the at least one user device and the at least one type of sensor data;
(iv) control the juvenile product based on the data received from the at least one user device, the at least one type of sensor data, and the at least one determined state; and
(v) transmit status data to the at least one user device, wherein the status data is based on the at least one determined state, wherein the status data includes instructions to perform a maintenance operation or to upgrade or replace the juvenile product.

2. The juvenile product of claim 1, comprising at least one of the following: a car seat, a stroller, a booster, a playpen, a motion device, bouncer, high chair, or any combination thereof.

3. The juvenile product of claim 1, wherein the at least one sensor comprises at least one of the following: an accelerometer, a gyroscope, a pressure transducer, an audio transducer, an image capture device, a current sensor, a heat sensor, or any combination thereof.

4. The juvenile product of claim 1, further comprising firmware embedded in the at least one processor or on a computer-readable medium, wherein the firmware is updated based on data received from the at least one user device.

5. The juvenile product of claim 1, wherein the at least one processor is further configured to communicate the status data to a remote server computer, and wherein the remote server computer is configured to generate analytics data concerning use of the juvenile product over a period of time.

6. The juvenile product of claim 1, wherein the at least one type of sensor data includes at least one of audio data and image data, and wherein the at least one processor is configured to process the at least one of the audio data and the image data to determine the at least one state of the juvenile using the product.

7. The juvenile product of claim 1, wherein the at least one type of sensor data indicates a location of the juvenile product.

8. The juvenile product of claim 1, wherein the at least one type of sensor data indicates a distance traveled by the juvenile product.

9. The juvenile product of claim 1, wherein the at least one type of sensor data includes physiological data of the juvenile using the juvenile product.

10. A mobile application for monitoring and/or controlling a juvenile product, the mobile application comprising at least one non-transitory computer-readable medium comprising program instructions that, when executed by at least one processor of a user device, causes a user device to:
receive data from the juvenile product;
generate at least one user interface comprising a plurality of selectable options for controlling the juvenile product;
transmit data to the juvenile product, the transmitted data configured to control the juvenile product based on user input received through the at least one user interface;
receive product registration input data from the juvenile product, the product registration input data including a serial number of the juvenile product; and
transmit the product registration input data in association with user registration input data to at least one remote server.

11. The mobile application of claim 10, wherein the program instructions, when executed, further cause the user device to:
retrieve instruction information from at least one server computer in response to data received from the juvenile product; and
display the instruction information on the at least one user interface.

12. The mobile application of claim 10, wherein the program instructions, when executed, further cause the user device to: display an alert on the at least one user interface based on the status data received from the juvenile product.

13. The mobile application of claim 12, wherein the alert indicates at least one of the following: the juvenile product is improperly set-up, the juvenile product is improperly used, a battery level is low, the juvenile product has been used for longer than a predetermined period of time, the juvenile product is improperly configured, the juvenile product requires maintenance, the juvenile product requires an upgrade or replacement, or any combination thereof.

14. The mobile application of claim 10, wherein the program instructions, when executed, further cause the user device to receive at least one of image data and audio data from at least one of a camera and a microphone integrated or on the juvenile product.

15. The mobile application of claim 14, wherein the program instructions, when executed, further cause the user device to: determine a state of a juvenile based on the at least one of the image data and the audio data received from the at juvenile product

16. The mobile application of claim 10, wherein the program instructions, when executed, further cause the user device to: locate the juvenile product based on at least one of the following: GPS data associated with the juvenile product, signals received from the juvenile product, or any combination thereof.

17. The mobile application of claim 10, wherein the program instructions, when executed, further cause the user device to: transmit analytics data based on usage of the juvenile product to at least one remote server computer.

18. A wireless communication method for a juvenile product comprising:
sensing, by at least one sensor, at least one type of sensor data on at least one of the juvenile product, a juvenile using the juvenile product, and an environment of the juvenile product;
receiving, by at least one processor, data from at least one user device;
receiving, by the at least one processor, the at least one type of sensor data from the at least one sensor;
determining, by the at least one processor, at least one state of at least one of the juvenile product, the juvenile using the juvenile product, and the environment of the juvenile product based on at least one of the data received from the at least one user device and the at least one type of sensor data;
controlling, by the at least one processor, the juvenile product based on the data received from the at least one user device, the at least one type of sensor data, and the at least one determined state; and
transmitting, by the at least one processor, status data to the at least one user device, wherein the status data is based on the at least one determined state, wherein the status data includes instructions to perform a maintenance operation or to upgrade or replace the juvenile product.

19. The juvenile product of claim 18, wherein the at least one type of sensor data includes physiological data of the juvenile using the juvenile product.

20. The juvenile product of claim 1, further comprising:
transmitting, by the at least one processor, the status data to a remote server computer.
